(19) United States
(12) Patent Application Publication
(10) Pub. No.: US 2013/0022754 A1
(43) Pub. Date: Jan. 24, 2013

(54) PRINTING

(71) Applicants: Peter Andrew Reath Bennett, Yorkshire (GB); John David Adamson, Cumbria (GB); Rodney Martin Potts, Yorkshire (GB)

(72) Inventors: Peter Andrew Reath Bennett, Yorkshire (GB); John David Adamson, Cumbria (GB); Rodney Martin Potts, Yorkshire (GB)

(73) Assignee: J P IMAGING LIMITED, Merseyside (GB)

(21) Appl. No.: 13/634,985

(22) PCT Filed: Mar. 18, 2011
(86) PCT No.: PCT/GB2011/050548

§ 371 Date: Oct. 5, 2012

(30) Foreign Application Priority Data
Mar. 18, 2010 (GB) 1004544.1

(51) Int. Cl. C23C 28/00; C25D 7/00; B05D 3/06

(52) U.S. Cl. 427/532; 205/50

(57) ABSTRACT

A printing form precursor comprises a printing surface which comprises an anodic layer which is hydrophobic and capable of being made hydrophilic by fast laser pulses but capable of becoming hydrophobic again, preferably for re-use, if desired. These changes are influenced by thickness of the anodic layer, and by alloying elements in the anodic layer. Benefit is gained also from using a darkly coloured anodic layer and by permitting the change from hydrophilic to hydrophobic to take place in a carbonaceous or siliceous atmosphere. By such means the invention achieves the goal of providing a printing form precursor which does not need a chemical developer, and which can be used multiple times, to print different images.

This invention relates to improvements in printing, and in particular to lithographic printing forms having new capabilities, and to the use of such printing forms in lithographic printing.

Fundamentally, all lithographic printing processes take a printing form precursor which has a specially prepared surface which is uniform throughout; and modifies selected regions of it, leaving reciprocal regions unmodified. Many processes subject the printing form precursor to a chemical developer which acts upon either the modified or unmodified regions, to produce the differentiation needed for printing. Optionally the developed surface is treated to harden the remaining areas of the coating, for example by baking, prior to printing.

It should be noted that in this specification we use the term ‘printing form precursor’ to denote the initial article having a uniform surface, undifferentiated as regards the acceptance or rejection of ink; and ‘printing form’ to denote the article now with a differentiated surface which can be printed from. The term printing form herein may be substituted by the term printing plate. The term printing form is preferred in describing and defining the invention because it is of broad connotation. The term printing plate or just plate may nevertheless be used herein for ease of reading.

Printing form precursors having thereon a coating of a chemical composition may be altered in their propensity to be dissolved in a developer solution, by suitable energy. With some compositions the energy renders the areas of the coating subjected to the energy more soluble in the developer. Because of the solubility differential resulting from the imagewise application of energy, on contact with the developer the imaged areas are dissolved away leaving non-imaged areas where the coating remains. Such systems are called positive working systems. The remaining areas of coating are generally oleophilic, and ink-accepting. In the dissolved-away areas the substrate is exposed, and is generally hydrophilic and able to accept the water component of the ink/water fount solution. Thus, printing may be carried out.

In alternative systems it is the areas which have been imagewise subjected to energy which are rendered less soluble than the imaged areas, so that it is the non-imaged areas in which the coating is dissolved away. Such systems are called negative working systems.

With traditional technology a printing plate is used for one image and is then discarded, or recycled. The printing industry is a vast industry and the environmental implications of the current approach of using a printing plate and scrapping it, or even using it and recovering the substrates, such as a metal, for re-use, still at a heavy environmental cost, are enormous.

These existing processes also have a heavy requirement for chemicals. There is the imagable coating itself, which generally comprises a polymer and an imaging chemistry, co-deposited from a solvent, the latter having to be removed by evaporation. There is the developer solution. The solvent and the developer solution must be disposed of or worked up for re-use. There are the chemicals needed for clean-up, recycling or disposal of the solvent and developer solution.

We have previously devised a method of printing comprising:
a) providing a printing form precursor having a printing surface which comprises an inorganic metal compound, uncoated by a developable image layer and uniform in its acceptance of an oleophilic printing ink;
b) subjecting the printing surface imagewise to electromagnetic radiation having a pulse duration of not greater than 1×10⁻⁶ seconds, in an imagewise manner, so as to increase the hydrophilicity of the printing surface where subjected to energy, sufficient to make the surface differentiated in its acceptance and non-acceptance of an ink; and
c) applying the ink to the printing surface and printing from the printing surface.
Step c) may be followed by:
d) causing or allowing the printing surface to undergo a reduction in hydrophilicity sufficient again to make the printing surface uniform in its acceptance of a printing ink, and
e) repeating at least steps b) and c).

In addition we have previously devised a printing form precursor comprising a printing surface which comprises an inorganic metal compound, the printing surface being hydrophobic and capable of being made hydrophilic where impinged upon by pulses of electromagnetic radiation of duration not greater than 1×10⁻⁶ seconds, but capable of becoming hydrophobic again, for re-use.

Our earlier findings are set forth in PCT/GB2009/051132.

The skilled person will understand what is meant by the terms “hydrophilic” and “hydrophobic”, and their derivative forms, used herein. These may be regarded as relative terms and that the essential point is that there may be a change, for imaging, so that the printing surface becomes more hydrophilic, and the reversion step in which the printing surface becomes more hydrophobic; in any event, in this invention, a degree sufficient to show, for a phase of operation, a differentially ink-accepting characteristic. For practical purposes, in this field, in which greasy inks are customarily used, “hydrophilic” may be regarded as having the same meaning as “oleophobic”; and “hydrophobic” may be regarded as having the same meaning as “oleophilic”. The respective terms may be substituted for each other in this specification.

In an extremely simple way these terms can be considered in relation to droplets of water on the printing surface. When a surface is suitably hydrophobic for the purposes of the present invention, i.e. before the image-forming step b), the droplets form beads, upstanding in appearance, and of small contact area with the surface. Preferably these bead-like droplets have a contact angle with the printing surface of 45° or more, preferably 50° or more, preferably 55° or more, preferably 60° or more; and most preferably 65° or more When the surface is suitably hydrophilic for the purposes of the present invention, i.e. in regions following the image-forming step b), the contact area is larger, and water more extensively wets the surface. Preferably these droplets have a contact angle with the printing surface of 35° or less, preferably of 30° or less, and most preferably of 25° or less.

The improvements we have now made relate to printing form precursors having anodic layers.

In a first aspect of the present invention there is described a printing form precursor having an anodised metal oxide printing surface (or “anodic layer” elsewhere herein), the printing surface being hydrophobic and capable of being made hydrophilic by electromagnetic radiation having a pulse duration of not greater than 1×10⁻⁶ seconds, wherein the metal oxide printing surface has a weight of at least 3.5 gm⁻². Preferably the printing surface is capable of becoming hydrophobic again, for re-use.

In accordance with a second aspect of the present invention there is provided the use of an anodised metal oxide printing surface of weight at least 3.5 gm⁻², as an imaging and printing surface, in order to achieve improved ablation or spalling resistance. Preferably the ablation or spalling resistance is such as to allow the printing form precursor to be re-used.

In accordance with a third aspect of the present invention there is provided a method of printing which comprises carrying out steps a), b) and c) above; preferably followed by steps d) and e); in which the printing form precursor has anodised metal oxide printing surface of weight at least 3.5 gm⁻².

Preferably the anodic layer has a weight of at least 3.5 gm⁻², preferably at least 5.5 gm⁻², preferably at least 6.5 gm⁻², and most preferably of at least 8 gm⁻².

Preferably the anodic layer has a weight of up to 20 gm⁻².

A printing form precursor in which the imaging and printing surface is merely an anodic metal oxide is a new development in printing technology. When we tested anodic layers of different anodic coating weights we had no expectation of whether low or high coating weight anodic layers would perform better, or, indeed, whether there would be any difference. It was a considerable surprise, therefore, to find that anodic layers of higher coating weights offered a much better prospect of achieving a non-ablative or non-spalling, or a low-ablative or low-spelling, and preferably reusable, printing form precursor. In fact the thinner anodic layers appear to be much more significantly damaged by the pulsed imaging energy, than thicker anodic layers.

We have also determined that there is benefit in colouring an anodic layer.

In accordance with a fourth aspect of the present invention there is provided a printing form precursor having an anodic layer as the printing surface, the printing surface being hydrophobic and capable of being made hydrophilic where impinged upon by pulses of electromagnetic radiation of duration not greater than 1×10⁻⁶ seconds, wherein the printing surface is coloured. Preferably the printing surface is capable of becoming hydrophobic again, for re-use.

By default an anodic layer is pale, unless steps are taken to colour it. We have determined that this is non-optimal for a printing form precursor which does not have a chemical coating layer, and which is preferably reusable. We have determined that when a printing form precursor of the type we have described herein is imaged for the first time it may, in some embodiments, retain its first image as a “ghost” image. This “ghost” image may be seen as the plate is reused, and may not even fade with time, or with successive re-uses. This “ghost” image plays no part in subsequent printing operations. It has no effect on print quality from later imaging and printing operations. However it is potentially misleading to a printer.

Preferably the anodic printing surface is sufficiently dark to mask any ghost image which may be present. For example the colouration thereof may be dark blue, dark green, dark brown, bronze, black, dark red, purple, etc.

With this colouration the printer may not be able to see the true image formed in the printing operation, when the anodic layer is covered. Many printers are happy already with dark plates. Also, inspection techniques which do not use visible light may be employed. In any case, the avoidance of a potentially misleading ghost image is desirable.

The colouration may be achieved by incorporation in the anodising bath of a dye or pigment or other chemical which yields a coloured anodic layer. This can happen even when the other chemical is not itself coloured or is a different colour, to the colour produced in the anodic layer. For example tin sulphate which is a white solid and colourless when present in an anodising bath can make the anodic layer bronze-black. Anodising technologists have available to them a range of dyes or pigments they can use in an anodising process to give any one of a range of colours, to the anodic layers.

An alternative is to colour the anodic layer after anodising, for example via a spraying or dipping operation.

A dye or pigment used to colourise the anodic layer may be a colorant which has an absorbance spectrum that overlaps with the incident pulsed radiation and hence radiation absorbance may take place directly.

We have found it to be of benefit in terms of achievement of a suitable oleophilic condition of the printing surface before first use of the printing plate precursor, or in assisting or promoting step d), if the printing form precursor is exposed to any carbonaceous or siliceous atmosphere. A carbonaceous atmosphere may be a liquid or gaseous atmosphere comprising one or more of: carbon monoxide, carbon dioxide, an alkane, an alkene, an alkyne, an organic acid, an ester, an aldehyde, an alcohol, a fuel, such as petrol, an oil, for example a vegetable oil or a mineral oil, or a white spirit. Silanes may also promote oleophilicity.

Such exposure to a carbonaceous or siliceous atmosphere preferably takes places as a final step of manufacture but may take place at a part of one of the steps defined herein.

In a fifth aspect there is provided a method of conditioning a printing form precursor, by exposure to such an atmosphere.

The aspects of the present invention described above are potentially of value with an anodic layer of any material, but preferably employ an anodic metal oxide of aluminium, titanium, magnesium, zinc, niobium and tantalum. Especially preferred materials are titanium and, especially, aluminium.

We have also found that the imaging properties of printing form precursors of the aluminium/aluminium oxide type may be influenced by alloying elements within an aluminium alloy being anodised and that certain alloying elements are particularly helpful in causing or allowing the printing surface to become sufficiently oleophilic at the start of the method, for step a) to be achieved, and/or undergo a sufficient hydrophilicity reduction (step d) above); and/or of value in controlling the time to achieve a suitable degree of oleophilicity, either following manufacture, in step a), or for re-use in step d).

In accordance with a sixth aspect of the present invention there is provided a printing form precursor having a printing form precursor comprising an aluminium oxide printing surface on a metal base which has a major proportion of aluminium, and a minor proportion of an alloying element selected from one or more of manganese, zinc, copper, silicon, magnesium, zirconium or titanium, the printing surface being hydrophobic and capable of being made hydrophilic by electromagnetic radiation having a pulse duration of not greater than 1×10⁻⁶ seconds.

Magnesium and manganese are preferred in giving highly hydrophobic surfaces (in step d) above), in a reasonably short time. This a printing form precursor may become ready for re-use.

Manganese may be present in an amount of from 0.1 to 5%, preferably 0.2 to 2%, more preferably 0.3 to 1%, weight manganese per total metal weight.

Zinc may be present in an amount of from 0.1 to 5%, preferably 0.2 to 2%, more preferably 0.3 to 1%, weight zinc per total metal weight.

Copper may be present in an amount of from 0.1 to 5%, preferably 0.2 to 2%, more preferably 0.3 to 1%, weight copper per total metal weight.

Silicon may be present in an amount of from 0.1 to 5%, preferably 0.2 to 2%, more preferably 0.3 to 1%, weight silicon per total metal weight.

Magnesium may be present in an amount of from 0.1 to 5%, preferably 0.2 to 2%, more preferably 0.3 to 1%, weight magnesium per total metal weight.

Zirconium may be present in an amount of from 0.1 to 5%, preferably 0.2 to 2%, more preferably 0.3 to 1%, weight zirconium per total metal weight.

Titanium/titanium and zirconium/zirconium may be present in an amount of from 0.1 to 5%, preferably 0.2 to 2%, more preferably 0.3 to 1%, weight Titanium/titanium and zirconium/zirconium per total metal weight.

The total amount of such alloying elements present preferably does not exceed 30% weight per total metal weight; preferably does not exceed 20%, and preferably does not exceed 15%.

Manganese and magnesium are in preferred embodiments both present as alloying elements in the aluminium, each at the respective weights stated above.

The presence of further elements in the aluminium is not excluded. However we have not yet seen corresponding benefits in using other alloying elements.

The particular benefit of using the designated alloying element(s), especially manganese and/or magnesium, is in promoting the “reversion” of step d).

In accordance with a seventh aspect of the present invention there is provided the use of one of the alloying elements identified above as alloying elements in an aluminium substrate which has an anodic layer serving as a printing surface, in rendering the printing surface hydrophobic, following a stage in which it has been rendered hydrophilic by being impinged upon by pulses of electromagnetic radiation of duration not greater than 1×10⁻⁶ seconds.

In all embodiments the methods may include steps a), b) and c) above, followed by steps d) and e).

In addition to the beneficial effects of certain alloying elements in the substrate we have also discovered that the form of the oxide film is important. We prepared samples of degreased aluminium substrates electrochemically and anodised them under different conditions. The conditions were chosen to provide anodic films of varying density or pore size. Thus, anodising in cold sulphuric acid (hard anodising) provides a dense structure of very small pores whilst phosphoric acid anodising produces a structure with larger pores or cells. In our experiments we observed that the anodising which produced the larger pores is more hydrophilic (contact angle <10°) compared with the anodising which produced the smaller pores (20°).

Therefore by combining the effects of both alloy type and anodic layer porosity we are able to significantly adjust and maximise the contrast of a printing form depending upon application.

For example, a printing form prepared from an aluminium alloy in the 3000 series and/or the 5000 series, such as 3004 or 5374 each containing magnesium and manganese as the predominant alloy elements, and using phosphoric acid anodising, can optimise oleophilicity potentially before exposure and, potentially, hydrophilicity after exposure. The larger the difference between the exposed and unexposed contact angles the better print capability of the printing form.

It is preferred that the anodic layer has pores of size at least 0.03 μm, preferably at least 0.06 μm, most preferably at least 0.1 μm. As is standard, pore size herein means cell (pore) diameter as measured by inspection using a scanning electron microscope.

Any of the aspects which have been described above may be used in combination with any other aspects, and preferred features.

The features described below are features which may be used with all aspects of the present invention, or all combination of aspects and embodiments, unless it is stated not to be so, or the context demands otherwise.

The substrate may be grained; that is, given a chemical treatment with a solution, such as mineral acid, to develop the topography of the printing surface. However graining is not a necessary part of the present invention, and there may be useful embodiments which have not undergone graining.

A preferred anodising process employs phosphoric acid in the anodising bath. However sulphuric acid may still be used, as can other acids, such as chromic acid.

The metal compound may comprise a layer which forms naturally on a metal substrate under ambient conditions; for example an oxide layer on aluminium, titanium or zinc. Alternatively or additionally it may be provided, or built up, by a preparatory step of anodising, for example electrochemically anodising, or by corona discharge. A metal oxide can be provided on a metal substrate, e.g. of the same metal species as the substrate (e.g. Al/Al₂O₃) or as the oxide of an alloying element, e.g. chromium oxide on stainless steel or zinc oxide on brass. Alternatively it can be provided on a non-metal substrate (for example a plastics sheet), as will be later described.

A preferred metal substrate may be both grained and anodised, for example electrochemically grained, and electrochemically anodised.

The printing form precursor may be a plastics or plastics-containing sheet (preferably a polyester sheet or a fibre-reinforced plastics sheet, for example glass reinforced plastics (GRP), for example glass-reinforced epoxy resin sheet) onto which the metal compound is applied. This could be by a vapour deposition or sputtering method, by corona discharge, or by any anodising process. To achieve this by anodising the printing surface precursor requires a conductive layer. Conductive polymers are available but in a preferred method a metal layer is applied to the sheet, for example by vapour deposition, by casting, by solution deposition or by lamination. Reference is made to the laminates of aluminium and plastics described in U.S. Pat. No. 5,650,258 for more information as to how to provide such laminates. Whilst such laminates are of interest in the methods of the present invention no claim is made to any such laminates per se. Alternatively the substrate may be steel sheet of a grade and thickness such that it can be bent and flattened multiple times, without cracking or adopting an undesired permanent shape.

A metal substrate may optionally be coated with a protective surface to prevent chemical attack during the precursor manufacture or on the press from any pressroom product which the printing form may contact.

A preferred anodic metal oxide printing surface of utility in this invention may be subjected to a post-anodic treatment (PAT). Suitable post-anodic treatments include treatments by, for example, poly(vinylphosphonic acid), inorganic phosphates and fluoride-containing materials such as sodium fluoride and potassium hexafluorozirconate. However embodiments in which the substrate is not subjected to a post-anodic treatment are not excluded.

When we write herein that the metal compound printing surface is uncoated by a developable image layer we mean that it does not carry a layer which is developable imagewise, in a developer liquid. Such a layer typically comprises an organic material, such as a film-forming polymer. It may be said that the metal compound printing surface has no potential for providing energy-induced solubility differential in a developer liquid. Rather, the metal compound printing surface of the present invention may be “switched” by the incident energy between relatively ink-accepting and ink-rejecting states.

The metal compound printing surface provided in step a) is more hydrophobic than that produced in step b) by a degree sufficiently large to produce differentiation in ink-acceptance.

It is well known and accepted that the non-image aluminium oxide printing surface area of grained, anodised, post anodically treated and image layer coated lithographic plates, is strongly hydrophilic, with the image layer being hydrophobic. Indeed, and as has already been indicated, it is this differentiation in ink receptivity between image and non-image areas, which is the basis of the lithographic printing process. It was surprising to find therefore that non-coated lithographic aluminium oxide substrates had a higher water contact angle than had been expected and that the alumina surface was strongly hydrophobic. Also surprisingly, it has been found that exposure of this surface to energy as described in this invention, ‘switches’ the aluminium oxide substrate from hydrophobic to hydrophilic, effectively introducing a lithographic printing surface which is capable of generating good quality prints. Moreover, the exposed surface over a period of time, returns to a hydrophobic state and can then again be exposed to energy to render exposed areas hydrophilic once more and generate a new lithographic printing surface.

Therefore, for practical purposes the uncoated metal compound printing surface provided in step a) in the present invention is preferably such that it can be regarded as hydrophobic. We do not know why the printing forms of the present invention, whose printing surfaces are uncoated by image layers are, relatively, hydrophobic (there is a hypothesis that the relative hydrophobicity of the metallic compound may be due to atmospheric ‘adventitious carbon’ but this is not proven). Nor do we understand how they become hydrophilic on imagewise exposure to energy; nor how they subsequently return to the required hydrophobic condition. However such changes do occur and are exploited in the practice of the present invention.

There is some evidence that there are a number of parameters which may (probably independently) affect the time taken for the metallic compound to reach ‘first oleophilicity’ (this is the point where the metallic compound can be considered hydrophobic from a contact angle perspective).

Preliminary testing has shown that in the case of aluminium/aluminium oxide printing form precursors which are anodised, optionally grained and optionally given a post-anodic treatment, that the time to first oleophilicity (TFO) may be affected, for example, by the degree of anodising, by the presence or absence of electrochemical graining and by the nature and presence or absence of a post anodic treatment. This is in addition to the measures of the present invention, described earlier.

There are also some preliminary indications that the TFO can be affected by temperature—higher temperatures apparently lead more quickly to hydrophobisation.

With this initial evidence there are strong indications that a ‘control measure’ can be established to provide a consistent and relatively stable metallic compound surface for the manufacture of the printing plate precursor.

Step a) herein may include using such a control measure to control (preferably accelerate) the onset of the desired hydrophobic condition, when the initially provided surface was hydrophilic. Such a control measure may include a measure taken during any anodising or post-anodic treatment or the provision of a suitable environment; for example a gaseous environment; or the application of heat or other energy. As noted above we have found that a carbonaceous or silicious-containing environment is of particular interest.

Steps d) and e) are preferably carried out, but need not be. When they are carried out, the printing form is being re-used. However there may be great benefit even in using the printing form precursor only once, applying only steps a)-c). The printing form precursor, which has a metal compound image layer and no further coating containing an imaging chemistry, is advantageously simple and is expected to be inexpensive.

Optional step d) in which the printing surface becomes less hydrophilic is called “reversal” or “reversing” hereinafter.

Reversal control means may be used to control the reversal, for example the time required for reversal, or the extent of reversal.

We have already described different novel means of controlling or influencing the changes described with reference to steps a) to c), and preferably also steps d) and e). The following measures are further measures which we believe can have influence.

A reversing control means may be in the form of a reversing advancing means (which may also be called “reversing promoter” or “reversing accelerator”) or a reversing retarding means (which may also be called a “reversing decelerator”).

A reversing advancing means may be employed to effect or promote the reversal in hydrophilicity defined in optional step d) of the method of the invention when the surface would otherwise not self-reverse; or when it would self-reverse, but more slowly or less completely than is desired.

A reversing retarding means may be employed to retard the reversal in hydrophilicity defined in optional step d) of the method of the invention, when the surface would otherwise reverse more rapidly than is desired. It is believed that certain gaseous environments may delay the reversal in hydrophilicity defined in step d); for example helium or a helium-rich atmosphere (preferably at least 50% w/w helium, preferably at least 80% w/w helium), or oxygen or an oxygen-rich atmosphere (preferably at least 50% w/w oxygen, preferably at least 80% w/w oxygen) and nitrogen or a nitrogen-rich environment (preferably at least 90% w/w nitrogen). Such gases and blends of such gases may be used to control reversion time; potentially, to retard or shorten it.

Air may give reversal at a practicable speed and may itself be regarded as a reversing control means. References to acceleration or deceleration may be in comparison to air, as a reference.

In optional step d) the printing surface may suitably be exposed to a gas (including air).

Preferably, the printing surface is in a gaseous environment throughout step d), and preferably until step e) is commenced.

A reversing control means may be energy; particularly as a reversing advancing means.

In step d), when employed, the printing surface may be caused to undergo a reduction in hydrophilicity with the assistance of by an active step, for example overall chemical treatment or flood exposure to suitable heat or electromagnetic radiation (including heat). In other, passive, or natural or unassisted, embodiments, however, the printing surface is caused to undergo a reduction in hydrophilicity solely by the passage of time, preferably under ambient conditions (in air, ambient temperature e.g. 15-30° C.). Thus such a preferred printing surface may be said to be self-reversing, over a reversion period. Alternatively the change of step d) could involve a combination of an active step and a passive or natural or unassisted reversion period.

For convenience and ease of reading step d) and the invention as a whole will be discussed using the term ‘reversal’, and derivative terms. This does not mean to say, when steps d) and e) are carried out, that the invention requires precise restoration of the original characteristics of the printing surface. It is enough that there are changes from hydrophobicity, to hydrophilicity, to hydrophobicity, and so on if wished, enabling different images to be carried by, and printed from, the same printing surface. ‘Reversal’ essentially means that the differentiation caused by the imaging energy substantially disappears, so that what was recently the ‘printing form’ has of itself now become, once again, a ‘printing form precursor’, which can be used again.

Suitably the time periods involved in the method of the invention involving re-use—whether the reversal is wholly passive or a combination of active and passive—should be practicable for the printer. Preferably the printing surface remains sufficiently hydrophilic, after step b), for a printer to be able to use it for printing for a period of at least 4 hours, preferably at least 8 hours, more preferably at least 12 hours, measured from the image-forming step b). On the other hand, the printer will wish to re-use it in a new printing operation, after a suitable period, by which time it should have become sufficiently hydrophobic again. This period is preferably not greater than 72 hours, preferably not greater than 48 hours, more preferably not greater than 24 hours, measured from the image-forming step b).

In the method of the invention step e) is preferably repeated, along with steps b) and c).

Suitably steps b), c) and d) can be carried out at least 3 times. Suitably steps b), c) and d) can be carried out up to 20 times, suitably up to 10 times. They may, for example, suitably be carried out 4 or 5 times.

Step b) may involve, in a single stage of operation, delivery of sufficient energy, preferably delivered by a laser, to cause said increase in the hydrophilicity of the printing surface.

Preferably step b) employs an energy source which is digitally controlled.

Alternatively, in step b), energy may be delivered to the printing surface in two or more discrete stages, with the final stage causing the hydrophilicity of the printing surface to reach a desired level, and the previous stage, or stages, preparing the printing surface for that to happen. The previous stage(s), may be regarded as “priming” the surface. Suitably the energy delivered in the final stage is then less than that which would be required if it were the only stage of energy delivery in step b).

Indeed, the first stage(s) of energy delivery within step b) may be carried out as part of the manufacture of the printing form precursor, and puts the printing form precursor in a state of readiness, to be rendered hydrophilic by a relatively low dosage of energy supplied during use, by the printer.

Delivery of the energy in stages, as described above, may assist in achieving the desired change in hydrophilicity whilst minimising the risk of damage, for example irreversible ablative damage, caused by the energy.

Delivery of the energy in stages, as described above, may involve a first delivery of energy in a blanket of flood manner, for example during the printing form precursor manufacture, and a second delivery of energy in an imagewise manner, for example immediately prior to printing. The second delivery of energy may be delivered by a digital source, for example a laser.

In printing, an oleophilic ink applied to the printing form precursor would be able to coat the whole of its hydrophobic surface. Imagewise delivery of suitable energy leading to the creation of hydrophilic regions means that such regions will no longer accept the ink. Instead they preferentially accept the water present in the fountain solution.

Preferably the printing surface of a printing form precursor used in the invention is a substantially uniform surface.

The imaging energy may suitably be visible, ultra-violet or infra-red radiation.

The imaging energy is delivered in pulses which are very short and separated by much longer intervals.

The imaging energy is delivered by an ultra-short pulse or ultra-fast laser. Preferably the laser emits suitable pulses as such (i.e. is a dedicated pulse generator); preferably it is not a continuous wave laser whose output is modulated post-emission to form “pulses”. Preferably it is not a continuous wave (CW) laser whose output is modulated by electronic control of the laser power source. In such cases the power delivered by the “pulse” is no different, or not substantially different, from the power delivered by the non-modulated continuous wave output. In contrast it is preferred that the present invention uses pulses of intense power.

Suitable lasers for use in this invention may operate by Q switching, in which energy is built up to be released as pulses in avalanche events; mode locking, which uses optical interference to produce pulse-shaped “beats” of light; Cavity Dumping, in which a “door” is opened periodically to “dump” a burst of light; and Gain Switching, in which pulses are formed by quickly switching the optical gain in the laser medium used to generate the laser light.

Preferably the imaging energy is delivered in the form of pulses of electromagnetic radiation, preferably from an ultra-fast laser, such pulses being of duration not greater than 5×10⁻⁷ seconds, preferably not greater than 1×10⁻⁷, preferably not greater than 5×10⁻⁸, preferably not greater than 1×10⁻⁸ seconds, preferably not greater than 5×10⁻⁸ seconds, preferably not greater than 1×10⁻⁸ seconds, preferably not greater than 5×10⁻¹⁰ seconds, preferably not greater than 1×10⁻¹⁰ seconds, preferably not greater than 5×10¹¹ seconds, preferably not greater than 1×10¹¹ seconds. In some embodiments they may be of duration not greater than 5×10⁻¹² seconds, preferably not greater than 1×10⁻¹² seconds, preferably not greater than 1×10⁻¹³ seconds.

Preferably the pulses of electromagnetic radiation, preferably from an ultra-short pulse or ultra-fast laser, are of duration at least 1×10⁻¹⁸ seconds, preferably at least 1×10⁻¹⁶ seconds, preferably at least 1×10⁻¹⁵ seconds, preferably at least 5×10⁻¹⁵ seconds, preferably at least 1×10⁻¹⁴ seconds, preferably at least 5×10⁻¹⁴ seconds, preferably at least 1×10⁻¹³ seconds. In some embodiments they may be of duration at least 5×10⁻¹³ seconds, preferably at least 1×10⁻¹² seconds, preferably at least 5×10⁻¹² seconds.

One imaging tool suitable for use in the present invention is a femtosecond laser, for example emitting pulses of pulse duration in the range 50-400, for example 100-250, femtoseconds (fs).

Another imaging tool suitable for use in the present invention is a picosecond laser, for example emitting pulses of pulse duration in the range 1-50, for example 5-20, picoseconds (ps).

The pulses could be produced by a generator working at a fixed pulse repetition frequency, or in a region around a fixed pulse repetition frequency. Alternatively the pulses may be generated by a signal derived from the plate processing apparatus. Such a signal could typically have a small variation in pulse repetition frequency, or may have a large range in pulse repetition frequency, in principle being possible at very low rates. In all these cases there can be identified an average frequency of pulsing that would occur over the processing of a whole plate, and possibly a maximum pulse repetition frequency that may depend on the specification of the electromagnetic source or the specification of the plate exposure apparatus (platesetter). The average pulse repetition processing frequency is an important parameter of the production rate of the plate exposure apparatus (platesetter—as later described in more detail).

The average frequency of pulsing is preferably at least 100 pulses per second (100 Hz). Preferably it is at least 1000 pulses per second (1 kHz), preferably at least 10⁴ pulses per second (10 kHz), preferably at least 10⁵ pulses per second (100 kHz), and preferably at least 10⁶ pulses per second (1 MHz). In certain embodiments it could be higher, for example at least 10⁷ pulses per second (10 MHz), or at least 5×10⁷ pulses per second. These repetition rates are in the range 0.0001 MHz to 50 MHz, or higher, and might be expected to lead to plate production speeds, e.g. within a platesetter, of up to approximately 45 plates per hour.

Preferably the pulsed radiation is applied to an area of less than 1×10⁻⁴ cm² (e.g. a 113 μm diameter circle), preferably less than 5×10⁻⁵ cm² (e.g. a 80 μm diameter circle), preferably less than 1×10⁻⁵ cm² (e.g. a 35 μm diameter circle).

Preferably the pulsed radiation is applied to an area preferably greater than 1×10⁻⁷ cm² (e.g. a 3.5 μm diameter circle), preferably greater than 5×10⁻⁷ cm² (e.g. a 8 μm diameter circle), preferably greater than 1×10⁻⁶ cm² (e.g. a 11 μm diameter circle).

The delivery of the electromagnetic radiation may be even over time but this is not an essential feature of the invention. If the delivery of electromagnetic radiation varies over time, for example using a pulse repetition frequency sweep, definitions of parameters such as pulse duration and pulse separation given herein are to be taken as average values.

A convenient measure of the energy requirement of the process for forming a printing plate is to determine the energy density (energy per unit area) required to achieve the necessary changes in the plate surface. Where the electromagnetic energy is delivered continuously (continuous wave) at a Power, P (Watts) into a defined spot of diameter D (cm) (or for a non circular spot, some measure of the linear extent of that spot, e.g. the side length of a square spot) then the Power Density, i.e. Watts per unit area, is the Power divided by the spot area. It is common practice to ignore any numerical scaling factor for similar spot shapes, i.e. for a circular spot it is common to divide the power by the square of the diameter, P/D². To get the energy density it is necessary to estimate the time that the spot is exposed for. A simple estimate of this is to take the time that the beam takes to traverse the spot, i.e. the spot diameter divided by the traverse speed, v (cm/s) of the electromagnetic beam. This is D/v. The energy density is the power density multiplied by the exposure time, which is given by the formula P/Dv (J/cm²). This definition for the energy density is commonly referred to as the “Specific Energy” of a continuous wave process.

However this invention preferably uses pulsed radiation. For a pulsed electromagnetic beam the situation is more complicated. The simplest analysis is when each pulse of the source exposes a unique and previously unexposed spot on the surface. Furthermore if the beam is stationary at the arrival and throughout the duration of the pulse, then the energy density can be simply calculated. The beam power during the pulse can be estimated as the energy of the pulse, E (J), divided by the pulse length (s). The Power density is defined as this power divided by the spot area as discussed previously. However the exposure time is now solely the length of the pulse (s) and so the energy density becomes simply the pulse energy divided by the spot area, E/D². This energy density is commonly referred to as “Fluence” in the literature.

Normally it is not desirable to stop the beam movement to deliver pulses as this introduces delays and does not optimise the throughput of the process. Thus the beam traverses the surface during the extent of the pulse. This can be regarded as elongating the spot in the direction of beam travel by an extent given by multiplying the traverse speed v by the pulse length τ, with the spot area now being defined as D(D+τv). The formula for fluence, F, becomes:

F=E/(D(D+τv)=E/D²(1+τv/D)

If τv/D<<1 then the effect of traverse speed can be ignored. For a spot size of 20 μm travelling at 1 ms⁻¹ and a pulse length of 10 pS then τv/D=5×10⁻⁷ so the effect of travel speed on the fluence can be safely ignored.

Another factor is related to pulse overlap. If the speed is sufficiently high for a given frequency then the individual pulses do not overlap on the surface of the material. For this to happen then it is simple to show that fD/v<1, where f is the repetition frequency of the pulsed electromagnetic source. When the traverse speed is such that the pulses are not spatially separated then the effect of overlapping pulses on the material surface may have to be considered. It is common in the literature of short pulsed laser processing to refer to the effect of overlapping pulses as “incubation” and to measure the degree of incubation by estimating the number of overlapping pulses, N, as N=fD/v. N is sometimes referred to as the incubation number or incubation factor and does not need to be an integer. If N<1 there is no overlap of pulses. When N=1 (which is preferred) the exposure spots of successive pulses are touching, and as N increases there is increasing overlap of spots. For low values of N, say N<5, there may be little influence on incubation. However at high values of N a process may be regarded as a “quasi CW” process, and the energy density may be better expressed in terms of “Specific Energy”.

Finally after a substantial area of, or the whole of, a plate has been exposed then an additional pass, or passes may be made. These additional passes may increase or add to the material changes created by previous passes.

When pulse overlap is employed (N>1) it is believed that lower energy may be needed than when pulse overlapping is not used (N=1). Furthermore it is believed that the reduced pulse energy needed will allow the repetition rate of the pulsed electromagnetic source to be increased by a factor greater than the incubation number N, enabling the process to be faster than the process without overlapping pulses.

The present invention preferably employs a low value of N; thus “fluence”, in mJ/cm², is regarded as the most appropriate definition of energy density, for use in this invention.

Preferably the fluence in the method of the present invention is at least 1 mJ/cm², preferably at least 10 mJ/cm², preferably at least 30 mJ/cm², preferably at least 50 mJ/cm², for example at least 100 mJ/cm².

Preferably the fluence in the method of the present invention is not greater than 20,000 mJ/cm², preferably not greater than 10,000 mJ/cm², preferably not greater than 5,000 mJ/cm², preferably not greater than 2,000 mJ/cm², preferably not greater than 1,000 mJ/cm², preferably not greater than 500 mJ/cm², preferably not greater than 200 mJ/cm². It may be not greater than 100 mJ/cm², and in some embodiments not greater than 50 mJ/cm².

Preferably the pulse energy delivered in this method is at least 0.1 μJ, preferably at least 0.5 μJ, and preferably at least 1 μJ.

Preferably the pulse energy delivered in this method is up to 50 μJ, preferably up to 20 μJ, preferably up to 10 μJ, and preferably up to 5 μJ.

Preferably a region to be imaged in the method is subjected to one pass or traverse only, of the beam of electromagnetic imaging energy. However in other embodiments a plurality of passes may be employed, for example up to 10, suitably up to 5, for example 2. In such embodiments the first pulse has a pulse energy as defined above. Subsequent pulse(s) may have a pulse energy as defined above but this need not be the same pulse energy as the first pulse, or any other pulses; for example it may advantageously be less.

When multipass laser imaging is employed, it is intended that passes are made without significant delay between them and without treatments being applied between them (other than, if necessary, debris removal). It is desirable that any such treatments are carried out without removal of the plate from the platesetter. Preferably, however, no such treatments are required and the multipass imaging process is carried out in one stage (as opposed, for example, to two stages separated by a dwell time).

Preferably the method of the invention does not cause ablation; or, if it does, causes only insubstantial ablation; for example ablation at a level which does not require removal of debris between steps b) and d).

The pulse may generate a spot or pixel of any shape, for example circular, oval and rectangular, including square. Rectangular is preferred, as being able to provide full imaging of desired regions, without overlapping and/or missed regions.

The natural profile of a laser beam, by which is suitably meant the energy or intensity, is Gaussian; however other beam profiles are equally suitable to carry out the change described herein, especially laser beams with a square or rectangular profile (i.e. energy or intensity across the laser beam). The cross-sectional profile of the laser beam may be circular, elliptical, square or rectangular and preferably the intensity of the laser beam energy (or “profile” of the laser beam) is substantially uniform across the whole area of the cross-section.

Preferably the method employs, as the imaging device, a laser providing such pulses, for example a femtosecond or picosecond laser. Such lasers provide pulses of high intensity; they are not adapted or gated CW lasers. Alternatively the method may employ, as the imaging device, a nanosecond laser fitted with a device, such as a Q-switch, to release intense pulses of laser energy “stored” during dwell times (in which the laser was still pumped but not releasing the photon energy produced).

Preferably the imaging energy, of whatever type and however delivered, does not produce substantial heat at the impinged-upon surface.

Femtosecond and picosecond lasers are especially preferred.

Ultra-fast fibre lasers may be used, in which a chemically treated (“doped”) optical fibre forms the laser cavity. This optical fibre is “pumped” by laser diodes, and there are several proprietary technologies used to couple the pumped light from the laser diodes into the optical fibre. Such lasers have relatively few optical components and are inexpensive, efficient, compact and rugged. They are thus considered to be especially suitable for use in this invention. However other ultra-short pulse or ultra-fast lasers may be used.

A printing precursor of the present invention may be subjected to radiation during its manufacture. For example it may be flood exposed, in order to reduce the energy required to image it in use. Alternatively this could be done by the printer, before first use of the printing form precursor. It may thus be “primed” for use. Once reversion taken place in step d), it may again be flood exposed for the same purpose, by the printer.

The printing form precursor may, in some embodiments be exposed on an imaging device in one imaging step b) and transferred to a printing press, and later returned to the image device for the next (and any successive) imaging step b).

The imaging device may be a platesetter. To get a laser to expose a plate the laser, the plate, or both have to move so that the whole plate surface can be addressed—the process called rastering. The arrangement of the laser within a platesetter (frequently referred to as the ‘architecture’) can be accomplished in one of three basic ways. Each of these architectures may be used in the present invention, and has its own performance differences, advantages and disadvantages. In the Flat Bed architecture, the plate is mounted flat on a table and the laser scans across, then the table moves down by one pixel and the laser scans back again. In the Internal Drum architecture the plate is fixed into a shell and the imaging laser rotates at high speed in the centre of the drum (in most but not all internal drum setters the plate remains still and the laser moves laterally as well as longitudinally). In the third architecture, External Drum the plate is clamped onto the outside of a cylinder, and the laser (or quite commonly a number of, for example, laser diodes) is mounted on a bar; usually the cylinder rotates and the laser(s) track across the plate.

The printing form precursor may, in some embodiments, be exposed on a printing press.

A method which involves transferring the printing form precursor between an imaging device and a printing press may require a printing form precursor which can be reconfigured between a flat shape (when on the imaging device) and a cylindrical shape (when on the printing press).

Such a printing form precursor requires flexibility. Certain of the printing form precursors described above are sufficiently flexible to be reconfigured between flat and cylindrical forms several times, without distortion in its shape or damage to the printing surface. One example is a printing form precursor having a plastics base layer, for example having a polyester layer, for example of average thickness in the range 25 to 250 μm, preferably 100 to 150 μm, and an aluminium oxide layer, for example of average thickness as described above. Between the polyester layer and the aluminium oxide layer there may advantageously be an aluminium layer of average thickness in the range 10 to 50 μm, preferably 20 to 30 μm. Non-metallic (and metallic) substrates having metal oxide layers, or able to carry metal oxide layers, are described in U.S. Pat. No. 5,881,645, U.S. Pat. No. 6,105,500 and WO 98/52769 and they and variations thereof may provide flexible and non-brittle printing form precursors of utility in the present invention.

The printing form precursor may be a flat plate, a plate with a curved surface, for example a roller, e.g. for use on a printing press, or cylinder or sleeve for a cylinder, in each case, suitable for use on a printing press.

In accordance with the present invention the energy applied directly changes (i.e. without the agency of a developer) the characteristics of the printing surface, in a manner which may be exploited in printing. In this invention, which emphasises re-use, the method is preferably not carried out to the point where ablation occurs. Rather, the surface is modified non-catastrophically, so as to permit reversal, and preferably multiple reversals.

The printing form precursors of the present invention are non-organic in character in both image and non-image areas and are therefore unlikely to be susceptible to pressroom chemicals. Accordingly, reduced runlength and image blinding issues are unlikely to be encountered—a distinct advantage for the systems described. In contrast, traditional printing plates, carrying an organic image layer, are susceptible to damage from the printing press washing and cleaning media. In particular if printing inks which harden with UV light are employed, wash-out (or cleaning media) agents are used which have a high content of solvents (such as ethers, esters or ketones) or are even formulated entirely on the basis of organic solvents. These wash-out agents may cause considerable damage to the copying layer causing image ‘blinding’ (poor or inadequate acceptance of ink) or shorter press runs for example. In addition to the deleterious effects of UV inks on copying images, other pressroom chemicals such as fountain solutions, blanket washes and press washes, all of which may contain significant levels of organic solvents or auxiliaries, such as isopropyl alcohol or surfactants, may also cause short runlength and/or image blinding.

The invention will now be further described, by way of example, with reference to the following.

Unless otherwise stated, the printing form precursor used in these experiments is generated from degreased aluminium treated as follows:

Step 1 electrochemical graining with hydrochloric acid (8-10 gl⁻¹ at 30-33° C.)
Step 2 desmutting phosphoric acid (250 gl⁻¹ at 35° C.)
Step 3 electrochemical anodising with sulphuric acid (150 gl⁻¹ at 30-32° C.).

To provide an aluminium oxide layer having a mean thickness of approximately 2.5 gsm.

Unless otherwise stated, ultra-fast exposures were undertaken using a Clark femtosecond laser of pulse repetition frequency 1 kHz and wavelength 775 nm and using an energy of 6 μJ and a tracking speed of 20 mmsec⁻¹.

Example Sets 1 and 2 represent part of our earlier work, described in PCT/GB2009/051132, and are presented here for background. Example Sets 3 onwards illustrate, by way of example, the improvements we have now made.

### EXAMPLE SET 1

In this set of experiments the exposure of anodised aluminium sheets to ultra-fast (u-f) laser radiation was examined.

This set of experiments started with freshly prepared aluminium oxide/aluminium substrate, 0.3 mm gauge (degreased, grained roughened, desmutted and anodised, coating weight of 2.5 gm⁻², without being post-anodically treated) has a contact angle with water of around 15°. Contact angle means the angle between the surface of a drop of water and the printing surface of the substrate, where the water comes into contact with the printing surface.

When the substrate was allowed to age for four or five days the contact angle increased, until it reached a maximum of around 70°, as shown in Table 1 below. In other words the surface went from hydrophilic to hydrophobic.

TABLE 1
Effect of ageing after production on contact angle of water on an
aluminium oxide/aluminium substrate:

| | Time after manufacture | | | | | |
|---|---|---|---|---|---|---|
| | | | | | | 120 |
| | 5 mins | 6 hours | 24 hours | 48 hours | 96 hours | hours |
| Contact | 15° | 20° | 30° | 50° | 65° | 70° |
| angle | | | | | | |

On exposure of an ‘aged’ (>48 hours), hydrophobic, aluminium oxide/aluminium substrate to an ultra-fast laser beam (Clark ultra-fast laser operating under the following general conditions: wavelength of 775 nm, 30 μm spot size, pulse width 180 fs and with an energy density (fluence) of around 225 mJ/cm²), the contact angle was reduced to ˜20° i.e. the exposed area became more hydrophilic. The contact angle then stayed fairly constant for some 12 hours and then started to increase fairly rapidly so that some 16-18 hours after exposure, the contact angle was around 70° once more and the printing surface was once again hydrophobic. This is shown by the results in Table 2 below.

TABLE 2
Effect of time after u-f (“ultra-fast laser”) exposure on contact angle
of water on an aluminium oxide/aluminium grained and anodised
substrate:

| | Time after exposure | | | | | |
|---|---|---|---|---|---|---|
| | 5 mins | 1 hour | 4 hours | 12 hours | 16 hours | 18 hours |
| Contact | 20° | 20° | 20° | 30° | 55° | 70° |
| angle | | | | | | |

In further experimental work re-exposure of the printing surface described above >24 hours after the initial exposure and under laser conditions corresponding to those described above, again brought about a reduction in contact angle (i.e. an increase in hydrophilicity). This effect was observed for at least 5 exposure/re-exposure ‘cycles’.

It has been observed that reversion (i.e. to a hydrophobic state) occurs more rapidly the more time a printing surface has been exposed, and further suggests that measures to advance or retard the reversion of the printing form precursor may be feasible.

The results indicate the potential of u-f lasers to provide a ‘reversible’ or ‘rewriteable’ printing plate system.

### EXAMPLE SET 2

To further investigate the potential for the ‘multiple’ exposure and ‘multiple’ printing of an ultra-fast exposed aluminium plate, the following experiment was conducted. A grained and anodised aluminium plate (‘standard’ treatments as identified above, 2.5 gm⁻² anodic weight) was exposed (exposure 1) using an ultra-fast laser (Clark ultra-fast laser operating under the following general conditions: frequency of 1 kHz, 50 μm spot size, pulse width 240 femtoseconds and fluence of 225 mJ/cm²). The exposure target image comprised two ‘50% tint’ chequers and a non-printing image ‘moat’ around the chequer patterns (this, to prevent the oleophilic surrounding areas ‘swamping’ the non-printing image areas and masking any print differential). A simple offset press test (print test 1) was conducted on this as-imaged plate on a Heidelberg GTO press. Print testing took place within two and a half hours of the ultra-fast laser exposure being completed. After adjustment of ink water balance, 250 good quality prints were obtained, before printing was terminated.

The plate was then removed from the press, excess ink was removed from the plate and the plate was ‘reverted’ artificially to its hydrophobic state by heating at 150° C. for one hour followed by a ‘relaxation’ period of 30 minutes under ambient conditions. The plate was then subjected to the same exposure conditions (exposure 2) as in exposure 1 above and again placed on the printing press. After ink water balance adjustments, 250 good quality prints (print test 2) were again obtained.

### EXAMPLE SET 3

Our studies have now shown that control over anodic layer loss or damage on ultra-fast exposure may be possible by defining the thickness or weight of the anodic layer to be utilised.

### EXPERIMENTAL WORK

Samples of non-grained, anodised aluminium of varying anodic weights were prepared and exposed by ultra-fast laser as follows:

Clark femtosecond laser operating at a pulse repetition frequency of 1 kHz and wavelength 775 nm, a spot size of ˜30 μm, a pulse energy of 6 μJ and a tracking speed of 20 mmsec⁻¹.

Plates were weighed before and after the laser exposure and the contact angle measured.

### Data/Results:

| | | Anodic | Contact angle |
|---|---|---|---|
| Sample description | | weight loss on | after ultra-fast |
| Sample code | Anodic weight (gm⁻²) | exposure (gm⁻²) | exposure (°) |
| A | 2.7 | 1.57 | <10 |
| B | 5.9 | 0.525 | <10 |
| C | 10.1 | 0.25 | <10 |

From the above results it is apparent that more material is removed from an alumina substrate with a thinner anodic layer than with a thicker anodic layer.

This effect is not fully understood but it is possibly associated with a spallation effect. It is believed that the interaction of the high energy laser pulse with the underlying aluminium may be affected to a varying extent by the thickness of the anodic layer. The high energy imparted may be creating a compressive stress pulse in the substrate which propagates and reflects and ‘spalls’ or peels the thin alumina film. The degree of spallation may be dependent, at least to some extent, upon the thickness of the anodic layer.

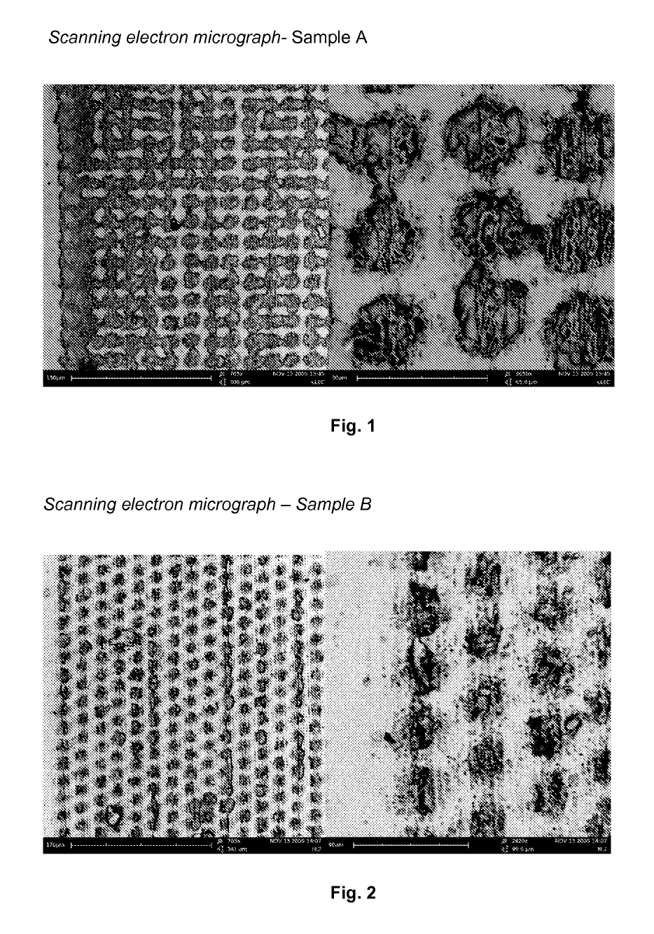

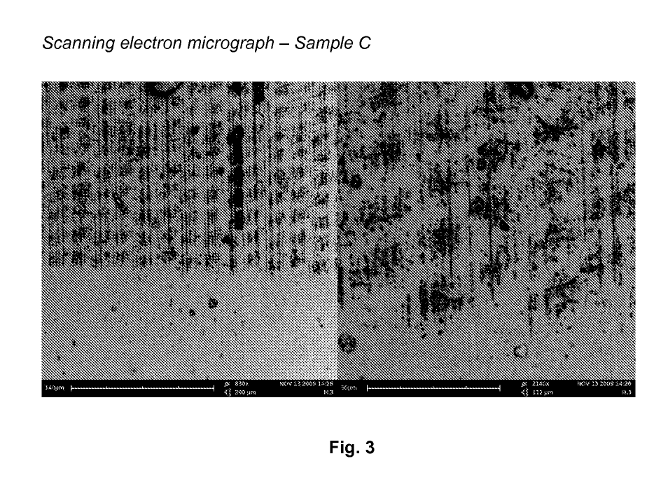

Scanning electron micrographs (SEM's) of the imaged alumina substrates of varying anodic thicknesses were taken and are shown in FIGS. 1-3. FIG. 1 shows Sample A, FIG. 2 shows Sample B, and FIG. 3 shows Example C.

FIG. 1 shows a significant disruption to the anodic layer and that this disruptive effect is, in some cases, causing pulses to ‘merge’. This merging may be as a result of, or may be the cause of, the ‘spelling’ or peeling of the anodic layer.

From FIG. 2, the disruptive effect of the same energy pulse appears much less—individual pulses retain their discrete, separated effect.

This lessening of the disruptive nature of the incident ultra-fast radiation with increasing anodic layer thickness, is supported and further emphasised by FIG. 3. It is clear here, that very little or no disruptive surface damage is caused by pulses of the same energy (6 μJ) as used for Sample A where the surface disruption was significant.

In conclusion, it is believed that control over the degree of anodic layer disruption on ultra-fast exposure, can be provided by adjustment and selection of the thickness of the anodic layer. It will be important to keep this disruption or degradation to a minimum in order to provide the most appropriate corrosion resistant and cohesive anodic layer for printing purposes. Moreover this need may assume even more importance in those instances where the media is to be re-used i.e. where “an expose-print-revert-re-expose-next print” cycle is employed.

### EXAMPLE SET 4

### Potential Affects of the Aluminium Alloy

This Example Set looked at the influence on ‘reversion time’ (RT) by the alloying elements used within the aluminium, a series of aluminium alloy samples containing different alloying elements were anodised under the following conditions:
sulphuric acid electrolyte (160 gl⁻¹)
electrolyte contains <4 gl⁻¹ aluminium
temperature of 30-32° C.
voltage of 18 volts
current density of 530 Am⁻²+/−15%
duration of 90 seconds+agitation

The alloys tested are characterised in composition terms as follows:

| Alloy | Si | Fe | Cu | Mn | Mg | Cr | Zn | V | Ti | Bi | Ga | Ni | Pb | Zr |
|---|---|---|---|---|---|---|---|---|---|---|---|---|---|---|
| 336 | 12.47 | | 1.1 | | 1.01 | | | | | | | 0.94 | | |
| 1050 | 0.07 | 0.3 | 0.01 | 0.003 | 0.008 | | 0.003 | 0.012 | 0.026 | | 0.013 | | | |
| 1052 | 0.064 | 0.35 | 0.002 | 0.009 | 0.236 | | 0.016 | 0.006 | 0.007 | | 0.011 | | | |
| 1060 | 0.25 | 0.35 | 0.05 | 0.03 | 0.03 | 0.03 | 0.05 | 0.05 | 0.03 | 0.03 | 0.03 | | 0.03 | 0.03 |
| 2024 | 0.5 | 0.5 | 3.8-4.9 | 0.30-0.9 | 1.2-1.8 | 0.1 | 0.25 | | 0.15 | | | | | |
| 3004 | 0.3 | 0.7 | 0.25 | 1.0-1.5 | 0.8-1.3 | | 0.25 | | | | | | | |
| 5754 | 0.06 | 0.19 | | 0.26 | 3.08 | | | | | | | | | |
| 6082 | 0.7-1.3 | 0.5 | 0.1 | 0.40-1.0 | 0.60-1.2 | 0.25 | 0.2 | | 0.1 | | | | | |
| 7075 | 0.4 | 0.5 | 1.2-2.0 | 0.3 | 2.1-2.9 | 0.18-0.28 | 5.1-6.1 | | 0.2 | | | | | |

The contact angles (i.e. the angle between the surface of a drop of water and the substrate, where the water comes into contact with the substrate) of the anodic surfaces of these as-manufactured plates were then measured over a period of time, and the following results obtained.

contact angle (°)

| Alloy | Day 0 | Day 1 | Day 3 | Day 9 |
|---|---|---|---|---|
| 336 cast | <10 | <50 | <60 | <60 |
| 1050 | <10 | <80 | <80 | <80 |
| 1052 | <10 | <60 | <70 | <60 |
| 1060 | <10 | <60 | <70 | <70 |
| 2024 | <10 | <60 | <70 | <70 |
| 3004 | <10 | <60 | <70 | <70 |
| 5754 | <10 | <70 | <70 | <70 |
| 6082 | <10 | <60 | <60 | <70 |
| 7075 | <10 | <60 | <60 | <70 |

It can be seen that each of the plates was initially hydrophilic and that at varying rates and to varying degrees (these factors being influenced, we believe, by the allowing elements present) the plates became hydrophobic, and suitable for imaging in the present invention.

These anodised materials were then exposed to ultra-fast radiation under the following general conditions: HiQ picosecond laser operating at a wavelength of 355 nm, a pulse width of 10 ps, a pulse energy of 12 μJ, a spot size of 20 μm and a frequency of 5 kHz.

The contact angles of the exposed areas were then measured over a period of time. The results are tabulated below.

| | contact angle measurements (°) | | | | | | | | | |
|---|---|---|---|---|---|---|---|---|---|---|
| | | | | <35 | <49 | <60 | <76 | <94 | <140 | <181 |
| alloy | fresh | <6 hours | <23 hours | hours | hours | hours | hours | hours | hours | hours |
| 336 | <10 | <10 | <10 | <25 | <20 | <25 | <25 | <25 | <30 | <40 |
| cast | | | | | | | | | | |
| 1050 | <10 | <20 | <20 | <30 | <40 | <40 | <45 | <45 | <50 | <70 |
| 1052 | <10 | <20 | <25 | <30 | <40 | <40 | <45 | <45 | <50 | <70 |
| 1060 | <10 | <20 | <25 | <40 | <40 | <40 | <40 | <50 | <50 | <60 |
| 2024 | <10 | <20 | <25 | <30 | <40 | <45 | <45 | <45 | <60 | <70 |
| 3004 | <10 | <20 | <30 | <40 | <45 | <50 | <60 | <60 | <80 | <100 |
| 5754 | <10 | <30 | <30 | <40 | <40 | <40 | <40 | <45 | <60 | <90 |
| 6082 | <10 | <20 | <25 | <30 | <40 | <40 | <40 | <50 | <50 | <60 |
| 7075 | <10 | <20 | <25 | <30 | <40 | <50 | <60 | <60 | <70 | <70 |

As can be seen from the above tabulated results above, the reversion times (RT) i.e. the time taken for the (exposed) hydrophilic alumina to revert to a hydrophobic state (contact angle >50°, varies with the particular alloy employed. It is believed that choice of alloying elements may provide a means to effect control over reversion times and hence provide a more robustly operating printing system.

### EXAMPLE SET 5

In addition to the beneficial effects of certain alloying elements in the substrate we have also discovered that the form of the oxide film is important. We prepared samples of degreased aluminium substrate and electrochemically anodised them under different conditions. The conditions were chosen to provide anodic films of varying density or porosity. The conditions employed included, for example, anodising in cold (˜5-10° C.) sulphuric acid (known as hard anodising) for an extended period of time (minutes), to provides a dense structure of very small pores or cells (˜0.005 μm); anodising in “standard” sulphuric acid conditions at an elevated temperature (˜30° C.) to produce larger pores or cells (˜0.015 μm); and electrochemically anodising in phosphoric acid at an elevated temperature (˜30° C.) producing a structure with still larger pores (˜0.5 μm) or cells. In our experiments we observed that more porous anodising is more hydrophilic (contact angle <10°) than less porous anodising (contact angle ˜20°). The tabulated data for 1050 aluminium alloy below illustrates our findings.

Anodising test conditions: phosphoric acid
‘standard’ anodising

| | |
|---|---|
| Test 1 | |
| 320 gl⁻¹ phosphoric acid | initial contact angle <10° |
| temperature 27-29° C. | pore size = 0.15 μm |
| duration 210 seconds | film thickness = 0.53 μm |
| current density 1 Adm⁻² | |
| voltage 30 V | |
| Test 2 | |
| 320 gl⁻¹ phosphoric acid | initial contact angle <10° |
| temperature 27-29° C. | pore size = 0.15 μm |
| duration 600 seconds | film thickness = 1.07 μm |
| current density 1 Adm⁻² | |
| voltage 30 V | |

Anodising test condition: sulphuric acid
‘hard’ anodising

| | |
|---|---|
| Test 3 | |
| 200 gl⁻¹ sulphuric acid | initial contact angle ~20° |
| temperature 5-9° C. | pore size = 0.005 μm |
| duration 300 seconds | film thickness = 4.8 μm |
| current density 2 Adm⁻² | |
| voltage 18 V | |
| Test 4 | |
| 200 gl⁻¹ sulphuric acid | initial contact angle ~20° |
| temperature 5-9° C. | pore size = 0.005 μm |
| duration 600 seconds | film thickness = 7.3 μm |
| current density 2 Adm⁻² | |
| voltage 18 V | |
| Test 5 | |
| 200 gl⁻¹ sulphuric acid | initial contact angle ~20° |
| temperature 5-10° C. | pore size = 0.005 μm |
| duration 15 minutes | film thickness = 10.7 μm |
| current density 2 Adm⁻² | |
| voltage 18 V | |
| Test 6 | |
| 200 gl⁻¹ sulphuric acid | initial contact angle ~20° |
| temperature 4-11° C. | pore size = 0.005 μm |
| duration 25 minutes | film thickness = 18.3 μm |
| current density 2 Adm⁻² | |
| voltage 18 V | |

Anodising test conditions: phosphoric acid
‘standard’ anodising

| | |
|---|---|
| Test 7 | |
| 200 gl⁻¹ sulphuric acid | initial contact angle ~20° |
| temperature 28-30° C. | pore size = 0.015 μm |
| duration 10 seconds | film thickness = 0.55 μm |
| current density 8 Adm⁻² | |
| voltage 18 V | |
| Test 8 | |
| 200 gl⁻¹ sulphuric acid | initial contact angle ~20° |
| temperature 28-30° C. | pore size = 0.015 μm |
| duration 45 seconds | film thickness = 1.1 μm |
| current density 8 Adm⁻² | |
| voltage 18 V | |
| Test 9 | |
| 200 gl⁻¹ sulphuric acid | initial contact angle ~20° |
| temperature 28-30° C. | pore size = 0.015 μm |
| duration 240 seconds | film thickness = 7.4 μm |
| current density 8 Adm⁻² | |
| voltage 18 V | |
| Test 10 | |
| 200 gl⁻¹ sulphuric acid | initial contact angle ~20° |
| temperature 28-30° C. | pore size = 0.015 μm |
| duration 550 seconds | film thickness = 15.3 μm |
| current density 8 Adm⁻² | |
| voltage 18 V | |

Pore size means the mean pore diameter as measured using SEM microscopy.

### EXAMPLE SET 6

The colouration of alumina layers was investigated both directly through the use of the dyes and indirectly through the use of other chemicals which can effect the colouration of the coating layer.

### Part A)

A number of colourants from the specialist range of dyes, Sanodal from Clariant, which have been designed for the dyeing of anodised aluminium, were individually used under recommended conditions in order to dye the anodic layer.

The dyes were individually applied from aqueous solution to the anodised aluminium as follows:

(i) Sanodal Black 2LW at a concentration of 10 g/l, and a temperature of 55-60° C. for a period of 15 minutes
(ii) Sanodal Black MLW at a concentration of 10 g/l, and a temperature of 55-60° C. for a period of 15 minutes
(iii) Sanodal Red B3LW at a concentration of 5 g/l, and a temperature of 55-60° C. for a period of 30 minutes

Each of the dyes coloured the anodic layer. Initial contact angle was less than 5°. The substrates were then allowed to oleophilise and were then exposed to ultra-fast radiation under the following general conditions: HiQ picosecond laser operating at a wavelength of 355 nm, a pulse width of 10 ps, a pulse energy of 12 μJ, a spot size of 20μ and a frequency of 5 kHz.

The exposed areas had become hydrophilic. There was no adverse effect on printing or reversion.

Imaged areas could not be differentiated colourimetrically from non-imaged areas by simple visual observation; no “ghost” image could be seen under normal viewing and in visible light.

### Part B)

In this instance, experimental work was conducted to integrally colour the anodic layer, within the electrochemical bath. The experimental conditions were as follows: aluminium was anodised under a potential of 30V AC for 10 minutes in an electrolyte comprising a solution of 15 g/l of SnSO₄ and 45 g/l H₂SO₄. Although SnSO₄ is a white chemical, and colourless in the anodising bath, the anodic layer so generated was bronze-black under normal viewing conditions in visible light. The initial contact angle was less than 5°.

The thus-coloured anodised substrate was then allowed to oleophilise and was then exposed to ultra-fast radiation under the following conditions: HiQ picosecond laser operating at a wavelength of 355 nm, a pulse width of 10 ps, a pulse energy of 12 μJ, a spot size of 20μ and a frequency of 5 kHz. The exposed areas had become hydrophilic. There was no adverse affect on printing or reversion.

The imaged area could not be differentiated colourimetrically from non-imaged areas by simple visual observation; no “ghost image” could be seen on the anodic surface under normal viewing conditions in visible light.

1. A printing form precursor having an anodised metal oxide printing surface (or “anodic layer” elsewhere herein), the printing surface being hydrophobic and capable of being made hydrophilic by electromagnetic radiation having a pulse duration of not greater than 1×10⁻⁶ seconds.

2. (canceled)

3. A method of printing comprising:
a) providing a printing form precursor having a printing surface which comprises an inorganic metal compound, uncoated by a developable image layer and uniform in its acceptance of an oleophilic printing ink;
b) subjecting the printing surface imagewise to electromagnetic radiation having a pulse duration of not greater than 1×10⁻⁶ seconds, in an imagewise manner, so as to increase the hydrophilicity of the printing surface where subjected to energy, sufficient to make the surface differentiated in its acceptance and non-acceptance of an ink; and
c) applying the ink to the printing surface and printing from the printing surface,
in which the printing form precursor has an anodised metal oxide printing surface of weight at least 3.5 gm⁻².

4. The printing form precursor of claim 1, wherein the printing surface is coloured; optionally dark blue, dark green, dark brown, bronze, black, dark red or purple.

5. A printing form precursor as claimed in claim 4 wherein the colouration is achieved by incorporation of a dye or pigment or other chemical, added to the anodising bath, and which yields a coloured anodic layer; or by colouring the anodic layer after anodising.

6. A method of conditioning a printing form precursor having an anodised metal oxide printing surface, the printing surface being hydrophobic and capable of being made hydrophilic by electromagnetic radiation having a pulse duration of not greater than 1×10⁻⁶ seconds, by exposure to such a carbonaceous or siliceous atmosphere.

7. (canceled)

8. The printing form precursor of claim 1, wherein the anodised metal oxide printing surface includes an aluminium oxide printing surface on a metal base which has a major proportion of aluminium, and a minor proportion of an alloying element selected from one or more of manganese, zinc, copper, silicon, magnesium, zirconium and titanium.

9. A printing form precursor as claimed in claim 8 wherein the metal base has manganese present in an amount of from 0.1 to 5% and/or magnesium present in an amount of from 0.1 to 5%, based on per total metal weight.

10. A printing form precursor as claimed claim 1 in which the anodised metal oxide is an anodic metal oxide produced by anodising in phosphoric acid.

11. A printing form precursor as claimed claim 1 in which the anodised metal oxide has pores with a pore size at least 0.03 μm.

12. A printing form precursor as claimed in claim 11 in which the pore size is at least 0.1 μm.

13. The printing form precursor of claim 1, wherein the anodised metal oxide is selected from aluminium, titanium, magnesium, zinc, niobium and tantalum.

14. The printing form precursor of claim 1, wherein the pulse duration is in the range from 1×10⁻¹⁰ seconds to 1×10⁻¹⁸ seconds.

15. The printing form of claim 1, wherein the metal oxide printing surface has a weight of at least 3.5 gm⁻².

16. The method of claim 3, further comprising:
d) causing or allowing the printing surface to undergo a reduction in hydrophilicity sufficient again to make the printing surface uniform in its acceptance of a printing ink; and
e) repeating at least steps b) and c).

17. The printing form precursor of claim 13, wherein the anodised metal oxide is titanium or aluminium.

18. The method of claim 6, wherein the pulse duration is in the range from 1×10⁻¹⁰ seconds to 1×10⁻¹⁸ seconds.
